(19) United States
(12) Patent Application Publication
(10) Pub. No.: US 2002/0140240 A1
(43) Pub. Date: Oct. 3, 2002

(54) Collector and bag for managing pet excrement

(76) Inventor: Ernest David Charette, Sarnia (CA)

Correspondence Address: James T. Nenniger, c/o Piasetzki & Nenniger, Suite 2308, 120 Adelaide Street West, Toronto, M5H 1T1, CA

(21) Appl. No.: 10/105,222

(22) Filed: Mar. 26, 2002

Related U.S. Application Data
(60) Provisional application No. 60/278,680, filed on Mar. 27, 2001.

(51) Int. Cl. A01K 29/00

(52) U.S. Cl. 294/1.5

(57) ABSTRACT

A portable pet excrement collector for use in association with a disposable bag is disclosed to manage pet excrement. The collector includes a collapsible reach extending body with a pair of bag supporting pivoting arms at a distal end of the body. A rotational stop is provided and is associated with each of said pivoting arms. At least one pivot element pivotally attaches each arm to said body, and said pivot element is sized and shaped to permit the bag supporting pivoting arms to pivot between a first lower open position in which the pivoting arms extend out from said body and a second raised position in which the pivoting arms are generally parallel to the body and adjacent to one another. The rotational stop supports the pivot arms in the lowered position, wherein a bag supported on said pivot arms is placed in an open position when said arms are lowered and a closed position when said arms are raised. In another aspect the invention provides a disposable pet excrement bag having an open top, and a first sleeve adjacent to the open top, the sleeve being sized and shaped to fit one of the pivoting arms and including a first sleeve stop; and a second sleeve adjacent to said opening sized and shaped to fit the other of said pivoting arms and including a second sleeve stop.

### FIELD OF THE INVENTION

This invention relates generally to the field of pet related devices and methods and more particularly to those devices and methods that may be used to collect and conveniently dispose of pet excrement.

### BACKGROUND OF THE INVENTION

In the past, pet owners were not concerned with excrement produced by their pets. More recently however, there has been a trend to make pet owners responsible for their pet's excrement, with the passing of by-laws and regulations aimed at requiring pet owners to pick up and remove their pet's excrement. Quite simply, the public is no longer willing, in many jurisdictions, to put up with pet excrement fouling common public spaces such as parks and the like. Such regulations have become known as “poop and scoop” laws.

Many owners currently resort to reusing used thin plastic bags to pick up their pet's waste. Such bags may be for example the typical t-shirt or grocery bag commonly given away with groceries in many supermarkets. However, this approach requires stooping over to pick and handle the excrement through the thin plastic bag and is both distasteful and not suitable in all cases. Often the used bags may have holes from their prior use. Holes are unsanitary as they can lead to direct contact with the excrement. Loose stools for example may be commingled with grass, or damp or wet conditions may interfere with the consistency of the excrement making it harder to pick up cleanly. Thus, various devices have been proposed to assist pet owners in keeping the public spaces free from pet excrement.

An example of such a device is disclosed in U.S. Pat. No. 6,039,370 to Dooley, Jr. et al. This patent teaches a reaching device for supporting a bag under the animal while it defecates. In this way, bending over and manual manipulation of the excrement through a thin plastic layer is avoided. However, this device suffers from a number of disadvantages. Firstly, it is bulky and thus difficult to carry discreetly. Secondly, to get the device in a ready to use position requires that it be extended, a bag deployed and two hands used to position the arms to support the bag in an open position. The use of two hands is awkward, for example if a pet owner has a dog on a lead and requires one hand to hold the lead to prevent the dog from running away. Further, the two handed deployment of this prior device takes time, which the pet owner might not have if the animal has a sudden urge. After catching the excrement the pet owner is required to raise the bag and while holding the device with one hand, somehow remove the bag full of excrement with the other hand from a pair of crooked arms, so the bag may be disposed of. All the while the bag is open, releasing bad smells and being liable to be spilled if the owner is the least bit clumsy. Further, the dog, having finished, is often eager to carry on and may be pulling at the lead. This requirement for three hands when there is a foul substance only loosely contained in an open bag is a recipe for disaster.

What is needed is a simple inexpensive device that can overcome the problems of the prior art. Most preferably such a device will permit the pet owner to responsibly collect and remove any pet excrement produced by their pet without exposing the pet owners to any undue risk of getting fouled themselves.

### SUMMARY OF THE INVENTION

The present invention is directed to a simple, inexpensive and effective device for dealing with pet excrement. In the preferred form the present invention is directed to two main aspects, namely, a portable pet excrement collector, and a disposable pet excrement bag for use in association with the collector of the present invention. The portable excrement collector of the present invention is easily and quickly deployed, most preferably requiring the use of only one hand. The portable pet excrement collector of the present invention includes a reach extending body, which is most preferably collapsible; to permit the device to be easily carried and stored conveniently out of the way, and to distance the pet owner from the pet excrement as it is collected. Further, once the excrement has been collected, the device may be swiftly placed in a safe carrying position with little or no time and in one easy motion. The device also is suitable for use with both conventional used grocery bags and the inventive bag of the present invention.

The present invention preferably provides a safe carrying position for such collected excrement so it may be discretely transported to a waste receptacle and disposed of. The bag aspect of the present invention is uniquely suited to the pet collector and permits simple and easy deployment on the collector device. The present invention further comprehends the bag be provided with a closable opening to positively retain the excrement therein.

Therefore according to a first aspect of the present invention there is provided a portable pet excrement collector for use in association with a disposable bag, said collector comprising:

a collapsible reach extending body;

a pair of bag supporting pivoting arms at a distal end of said body;

a rotational stop associated with each of said pivoting arms, and

at least one pivot element pivotally attaching each arm to said body, and said pivot element being sized and shaped to permit said bag supporting pivoting arms to pivot between in a first lower open position in which the pivoting arms extend out from said body and a second raised position in which the pivoting arms are generally parallel to said body and adjacent to one another, said rotational stop supporting said pivot arms in said lowered position, wherein a bag supported on said pivot arms is placed in an open position when said arms are lowered and a closed position when said arms are raised.

According to a second aspect of the present invention there is provided a disposable pet excrement bag for use in association with an excrement collector having two pivoting arms said bag comprising:

a receptacle of flexible plastic material with an opening at a top end thereof;

a first sleeve adjacent to said opening, sized and shaped to fit one of said pivoting arms and including a first sleeve stop; and

a second sleeve adjacent to said opening sized and shaped to fit the other of said pivoting arms and including a second sleeve stop.

### BRIEF DESCRIPTION OF THE DRAWINGS

Reference will now be made to preferred embodiments of the present invention, by way of example only, by reference to the following drawings in which:

FIG. 1 is a view of an extended pet excrement collector having a bag in an open position according to a first aspect of the present invention;

FIG. 2 is a side view of the collector and bag combination of FIG. 1;

FIG. 2a is a close up view of the circle 2a of FIG. 2;

FIG. 2b is a close up view of the circle 2b of FIG. 2;

FIG. 3 is a top view of the lower part of the collector of FIG. 1;

FIG. 3a is a close up side view FIG. 3;

FIG. 3b is a bottom view of FIG. 3;

FIG. 4 is a side view of the invention of FIG. 1 in a collapsed position;

FIG. 5 is a side view of a second embodiment of the present invention;

FIG. 6 is a front view of the embodiment of FIG. 5 in the direction of parallels B-B;

FIG. 7 is side view of the embodiment of FIG. 5 with one of the elements displaced;

FIG. 8 is a view of the embodiment of FIG. 5 having a disposable bag placed thereon;

FIG. 9 is a side view of a carrying case according to the present invention;

FIG. 10 is side view of the carrying case of FIG. 9 in a collapsed position;

FIG. 10a is a left end view along line 10a of FIG. 10;

FIG. 10b is a right end view along line 10b of FIG. 10;

FIG. 10c is a top view of the carrying case of FIG. 10;

FIG. 11 is a perspective view of a spatula according to the present invention;

FIG. 12 is a view of one form of clip element of the present invention;

FIG. 12a is an end view of the clip of FIG. 12

FIG. 13 is a front view of a second clip element according to the present invention;

FIG. 13a is a side view of the clip of FIG. 13;

FIG. 14 is a view of the present invention clipped to a leash;

FIG. 15 is a view of the present invention attached to a retractable leash having a handle;

FIG. 16, 16a, 16b, 16c and 16d are figures depicting the deployment of the present invention from the carrying case;

FIG. 17 is a further embodiment of the present invention;

FIG. 18 is a front view of the embodiment of FIG. 17 in the direction of arrows B-B; and

FIG. 19 is a side view showing the movement of the bag grasping arms of FIG. 17.

### DETAILED DESCRIPTION OF THE PREFERRED EMBODIMENTS

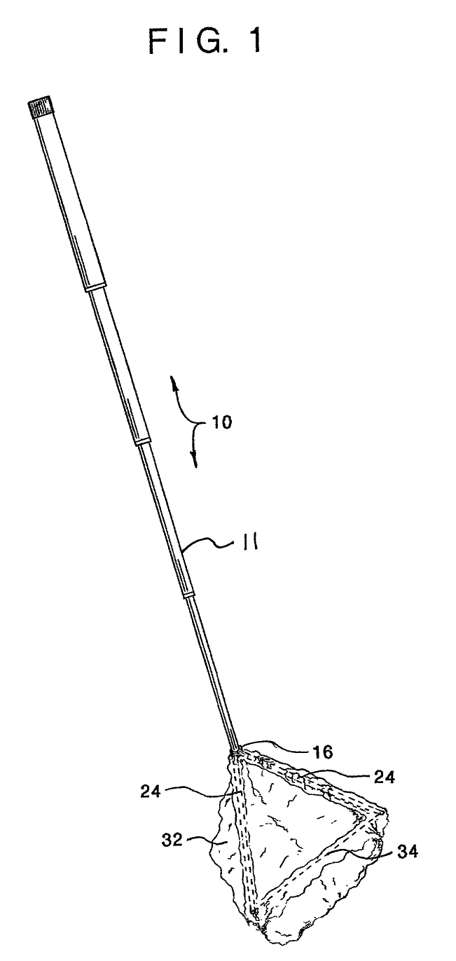

A portable pet excrement collector according to the present invention is shown generally at 10 in FIG. 1. The collector 10 includes a reach extending body 11, ending in a pivot element 16. Extending from the pivot element 16 is a pair of pivot arms 24, which support a bag 32 in an open position. The pivot arms 24 form two sides of a triangular shaped opening. A third side is shown as 34.

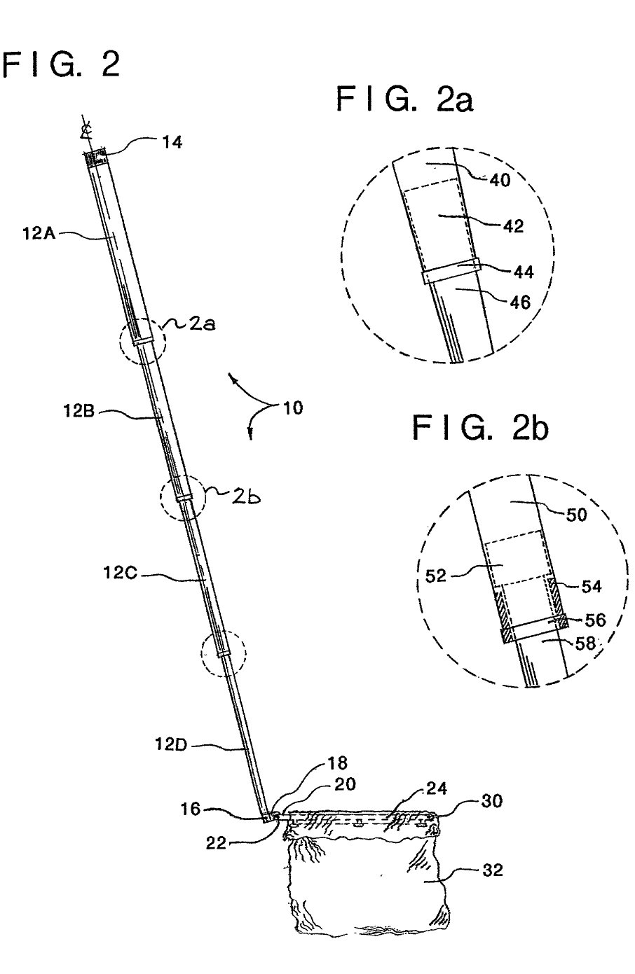

In FIG. 2 the reach extending body 11 is shown in more detail. In the preferred embodiment the reach extending body 11 is extendable between a shortened retracted position and an extended position as shown in FIGS. 1 and 2. While various forms of extendable bodies may be used good results have been achieved with the present invention with a telescoping collapsible body 11, which is circular in cross section. The body 11 includes an end cap 14 on a first body section 12a, into which is inserted, in telescoping engagement a body section 12b. Similarly body section 12c is in telescoping arrangement with section 12b as is body section 12d with body section 12c. The first body section 12a is preferably the largest in diameter and thus the easiest to hold.

More or fewer body sections can be used as needed. The present invention contemplates that the collapsed body will conveniently fit into a carrying pouch or case as explained in more detail below. Therefore, to facilitate the compact carrying arrangement, it is preferred to use an appropriate number of sections, of an appropriate length, to fit conveniently, for example, in a compact carrying case. Four sections of approximately 8 inches of length each have provided reasonable results. As will be appreciated by those skilled in the art any suitably strong and lightweight material may be used for the body sections and the arms 24, such as fibreglass, composites, plastic or other such materials.

Referring now to FIG. 2a, it can be seen that the upper telescoping section 40 houses the lower telescoping section 46 therein. This results in an overlapping portion 42. Overlapping portion 42 is sized and shaped to fit snugly within the upper portion 40 in a secure but releasable fit. To provide strength to the joint, a reinforcing ring 44, of the same or a different material, may also be used as shown. The reinforcing ring 44 is fixed to the upper telescoping section 40. What is desired is a locking taper between one section and the next, so that the adjacent sections are non-rotationally engaged. The present invention comprehends using a specific antirotational means to make the device easier to use. The anti-rotation means may comprise a locking taper, a roughened surface to facilitate frictional engagement or a series of small fingers or fins extending towards each other at the ends to ensure the two sections are not free to rotate relative to one another. The present invention is not limited to such anti-rotational means, but comprehends other forms of such attachment, such as out of round telescoping sections.

Referring to FIG. 2b, an alternate method of forming the telescoping sections is shown. In this embodiment the upper telescoping section 50 includes an inner stop 54. Lower telescoping section 58 includes an enlarged section 52, which, upon extension of the reach extending body 11 engages the stop 54. Again, a reinforcing ring element 56 may be used to make the telescoping sections stronger. Again, anti-rotational features can be incorporated into the device to prevent one section from rotating relative to the next section.

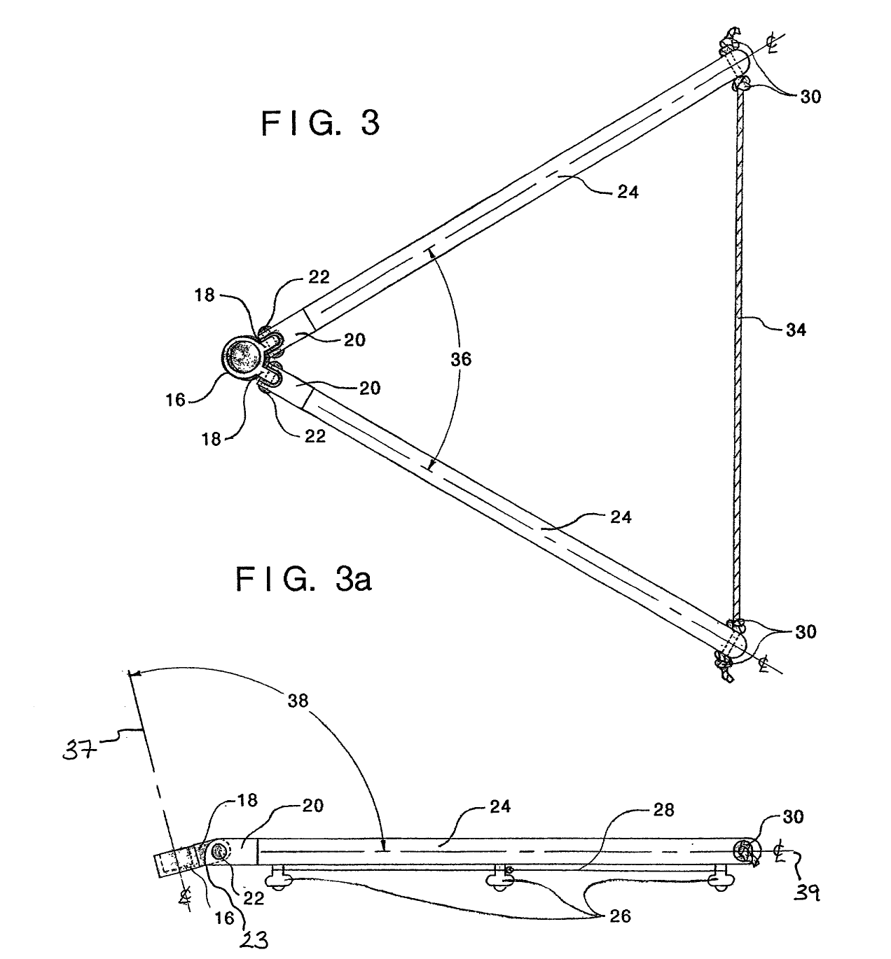

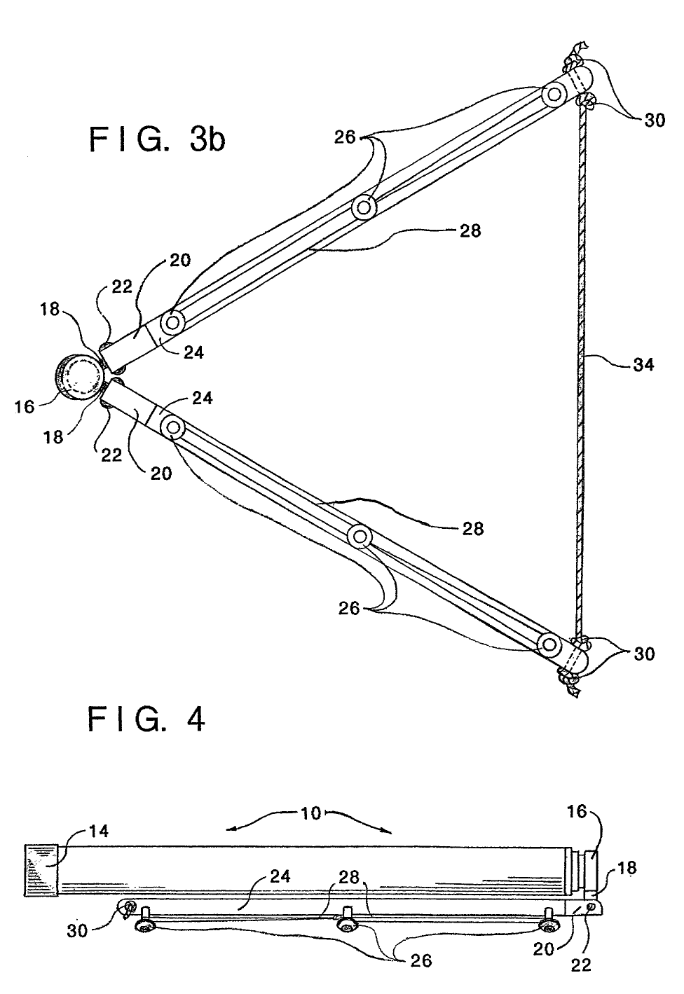

Referring again to FIG. 2, it can be seen that a pivot end fitting 16 is provided at the bottom of the reach extending handle 11. The fitting 16 includes outwardly extending ears 18 into which pivot pins 22 are mounted. In turn, a pair of pivot arms 20 is pivotally mounted on the pins 22. Each pivot arm 20 may include a form of bag retaining element, such as cleats 26, which are explained in more detail below. Also shown is a stop knot 30 in a flexible end member 34 (shown in FIG. 3) to support a bag 32.

Turning now to FIG. 3, a top view of the pivot fitting 16 showing the pivoting arm support elements of FIG. 2 is shown. In this view, the fitting 16 is shown more clearly having the two ears 18 in which the pivoting arms 20 are mounted by the respective pivots 22.

As can be seen in FIG. 2, the pivot arms 20 include arm extensions 24 which have at the distal or free end a flexible member 34 which may be affixed to a through bore by means of the stop knots 30. As will be understood from the discussion below, the flexible member 34, which is most preferably for example string, is not essential to all embodiments. However, in the circumstance where it is desired to reuse waste bags, such as t-shirt grocery bags, the flexible member 34 supports the third side of the triangle to keep the bag in an open position. As shown, the pivot arms 20 subtend an angle 36. An angle of 60° has been found adequate, but any angle that separates the pivot arms sufficiently to keep a bag in a reasonably open position will be suitable. Turning to FIG. 3a, the centre line 37 of the reach extending handle 11 is shown and an angle 38 is shown between the plane 39 of the pivoting arms 20 and the centre line 37. The preferred angle is greater than 90°, most preferably between about 100° and 125° and most preferably about 105°, but this deployment angle can be varied without departing from the scope of the present invention. Essentially, the deployment angle 38 needs to be sufficiently large to permit the reach extending body to position the pivoting arms under the back side of the pet, as explained in more detail below.

Also shown in FIG. 3a are cleats 26 upon which an elastic fastener 28 is attached. The cleats 26 are one form of bag attaching means for securing the bag supported by the arms 20 in position on the arms 20. The cleats are located below the arm to permit the bag to be wrapped around the arm and secured on the underside. This reduces the chances of the owner having to deal with a fouled plastic surface when removing the bag from the device. Further, the bag is fully wrapped around the pivot arm, preventing the pivot arm itself from being fouled. FIG. 3b is a bottom view of the embodiment of FIG. 3a showing the flexible attachment elements 28, such as rubber bands, snapped over the cleats 26. As can now be understood to place the bag on the arms, the bag is simply folded over the arms (from the inside) onto the cleats and then the elastic is snapped over the cleats to hold the edge of the bag in place. In this way the bag can be positively retained on the pivot arms. Although rubber bands are simple and inexpensive, other types of fasteners 28 are also comprehended.

As can also be seen in FIG. 3a, the ears 18 intersect with the pivoting end of 20 of the arm 24 at a stop 23. In this manner, the arms are prevented from over rotating and are held in an open and splayed position as shown in FIG. 3. As can now be understood the pivot arms are provided with a pivoting range of motion between the stopped lowered position and a raised position in which the pivot arms are generally parallel to the main body centreline and lie adjacent thereto. Because of the orientation of the pivot pins and the ears, the pivoting arms are guided between the lowered bag open position and the raised bag closed position. In other words the pivot element 16, in combination with the pins 22, defines pivot paths for the arms in an arc as shown.

FIG. 4 shows the present invention in a fully retracted position. As can be seen, the arms 20 have been folded back about the pivot 22 to be parallel to the axis of the main body 11. In addition, as the arms 20 rotate towards the main reach extending body 11, the pivoting arms come together in a side-by-side bag closing relationship. In this manner, the present invention presents a compact and fully retracted configuration. As will also be now appreciated as the arms are retracted and come together, which will have the effect of closing any bag supported thereon. Thus, the mere collapsing of the present invention has the effect of quickly closing the open top of a bag, reducing the likelihood of unwanted accidents, spills or the like as compared to the prior art.

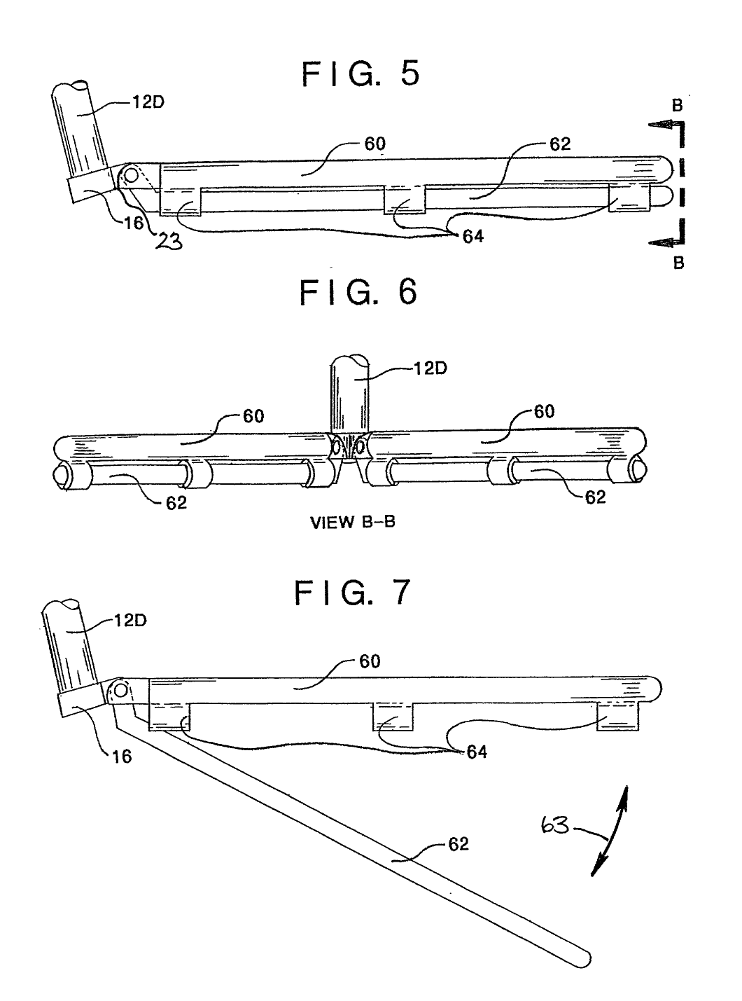

FIGS. 5, 6 and 7 show an alternate embodiment of the present invention in which the pivot arms 60 are formed with downwardly extending snaps 64. The snaps 64 retain a pivoting bag retaining arm 62 therein for securing the edge of a bag underneath the snaps 64. As can be seen in FIG. 7, the retaining arm 62 is moved along the direction of arrow 63 to engage or disengage from the snaps 64. Again this is desirable for use of used grocery store bags, as the disposable pet excrement bag.

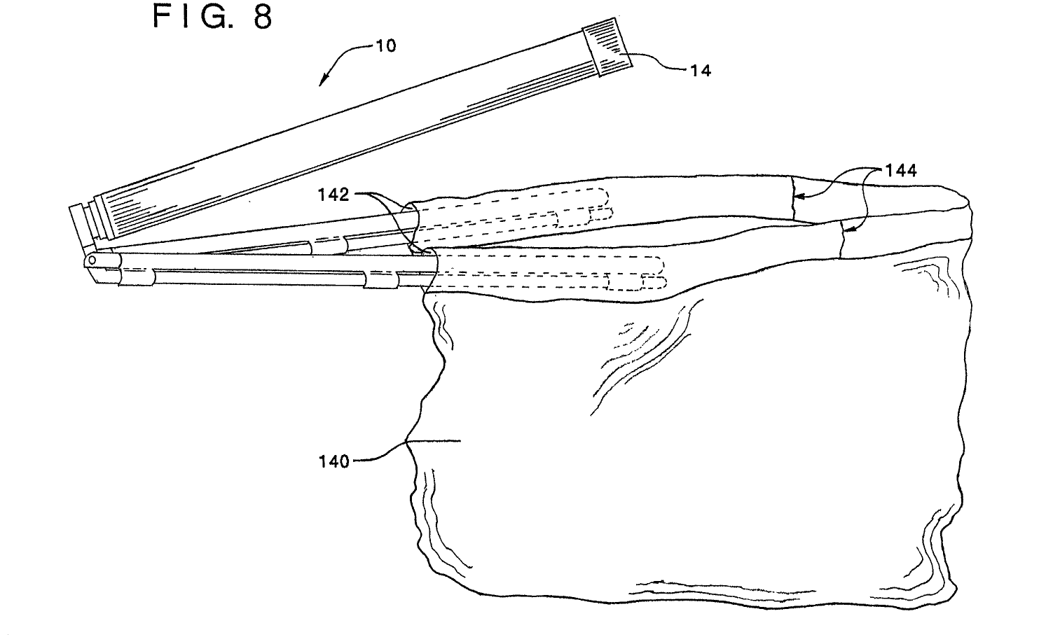

FIG. 8 shows a further embodiment of the present invention including a disposable pet excrement-retaining bag 140 purposely fabricated according to the present invention. The pet excrement-retaining bag 140 includes a closed bottom end and an open top end. About the perimeter of the open top end is formed a sleeve having a pair of adjacent openings 142. The sleeves includes arm stops, in the form of welds 144 at a distance corresponding to the length of the pivot arms. When the pivot arms are adjacent to the main body 11 as shown in FIG. 8, the ends of the pivot arms are closely spaced together. In this position the pivot arms can be inserted into the adjacent slots openings 142 until the arms reach the weld lines 144. Then, when the pivot arms are lowered and the bag is opened, the pivot arms pivot down and splay outwardly, and the bag itself stretches to form the flexible element extending between the outer ends of the arms. In this embodiment therefore no string element 34 is required as the third portion of the bag between the welds performs this function. As can now be appreciated the welds prevent over insertion of the arms, which if permitted could prevent full deployment of the arms creating a smaller open end at an undesirable angle. Thus the welds are positioned to permit full arm deployment with the third side of the bag being not too loose.

It can now be appreciated that the stops 144 prevent the bag from being over inserted onto the pivot arms 60. In the preferred embodiment, where angle between the arms 60 is 60°, the length of the closed end sleeves will equal the length of the distance between the stops 144. Thus, the bag opening is an equilateral triangle and when the bag is in a fully opened position the lip is stretched between the stops 144 and the ends of the pivot arms.

According to a further aspect of the present invention the bag 140 may also be provided with a bag closing means. The bag closing means may take the form, for example, of a peel and stick patch located inside of the top edge of the bag, or a simple drawstring to close the bag once it has been removed from the pivot arms 20. Other forms of bag closing means are also comprehended by the present invention.

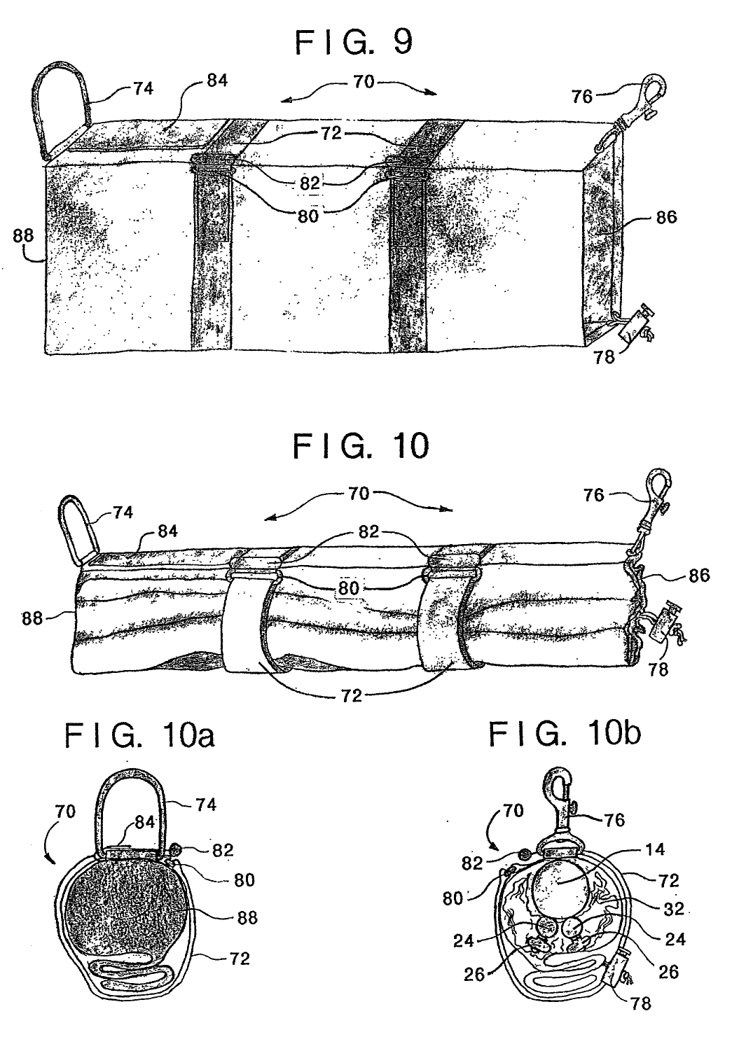

FIG. 9 is a view of a carrying case according to the present invention in which the present invention may be stored. As shown, the carrying case includes a hook element 74 at one end, and a latch element 76 at the other end. Most preferably, the body 70 of the carrying case has a closed end 88 and an open end 86. The open end 86 may include a drawstring closure element 78 as shown. In addition, for compactness, the body may include straps 72 with eyelet 80 and Velcro™ sections 82 for the purpose of collapsing the carrying case 70, and for allowing it to be enlarged when a fully loaded bag is being placed therein. Thus, the straps have the effect of making the case 70 expandable in size. The straps could also be in the form of elastic or stretchable members. A pocket flap 84 may also be provided.

Turning to FIG. 10, the carrying case 70 is shown in a collapsed position. FIG. 10a is a left end view of the case 70 of FIG. 10 showing the closed end 88 and collapsed by means of straps 72. FIG. 10b shows a right end view of the case 70 of FIG. 10 showing the open draw string end 86 with the end cap 14 of the body 11 and the two ends 24 of the pivot arms 20. Also shown is a collapsed bag 32.

In FIG. 10c, a further element of the present invention is presented, namely a spatula or scrapping element 90. The spatula 90 may include a cover 92 retained in place by an elastic member 94. In this embodiment, the spatula can be used to manipulate pet excrement which otherwise may be awkwardly positioned. Also shown is a pocket formed on the carrying case to retain the spatula therein. A D-shaped ring 74 may be attached to the case 70. The D-shaped ring is preferably large enough to slide over most conventionally sized dog leashes or leads.

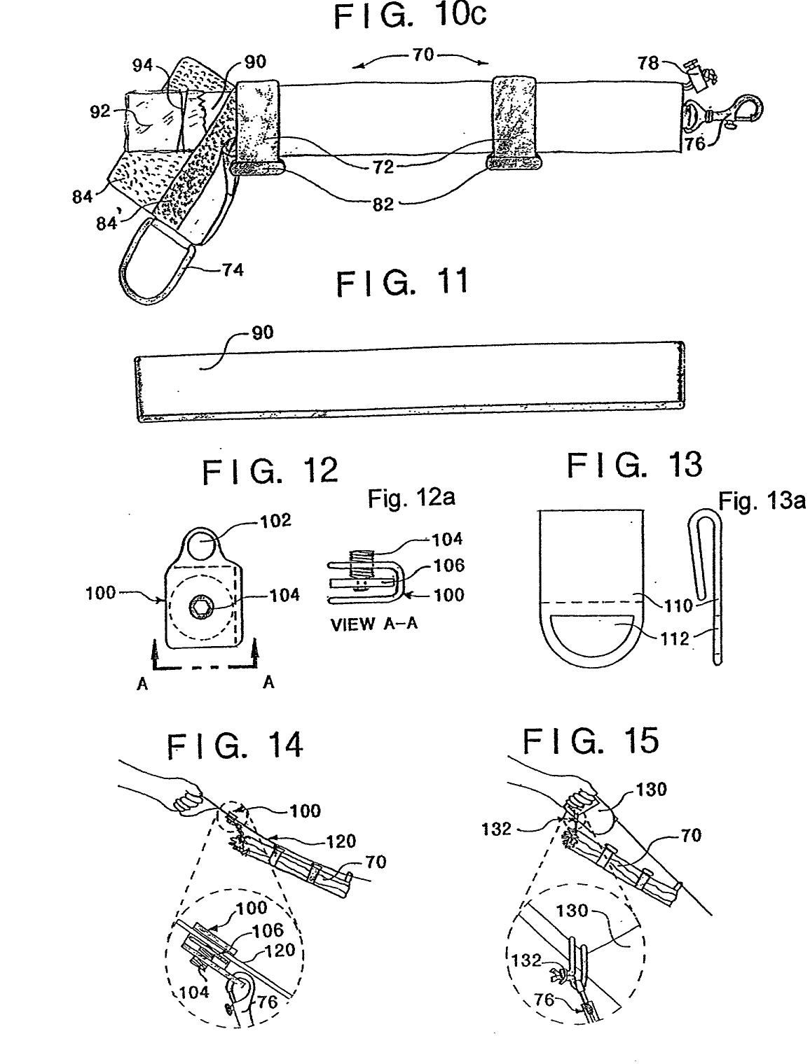

FIG. 11 shows a perspective view of the spatula 90, which may be a simple piece of plastic having chamfered ends as shown. The scrapping element 90 may be made from thin plastic and can be disposable, or can be reused as appropriate.

The carrying case 70 of the present invention may be attached to a conventional leash or handled retractable leash by any type of suitable fastener. One type of fastener is shown in FIG. 12 that includes a thumbnail screw 104 in a body element 100 having a clamping plate 106 for clamping onto a conventional cloth or leather leash 120 (shown in FIG. 14). This element 100 can be used to attach the hook 76 at the upper end of the case 70 in place on such a lead. FIG. 13 shows a second form of clip element 110, with an opening 112 which may be used to frictionally clip the present invention onto a person's belt or even onto the leash 120. In the event the pet owner prefers to use a retractable lead with a rigid handle 130, then as shown in FIG. 15 the case 70 may be simply tied thereto. In all cases the most preferred mounting of the case 70 is one which is somewhat secure against pulling and which is in place without needing to be separately held.

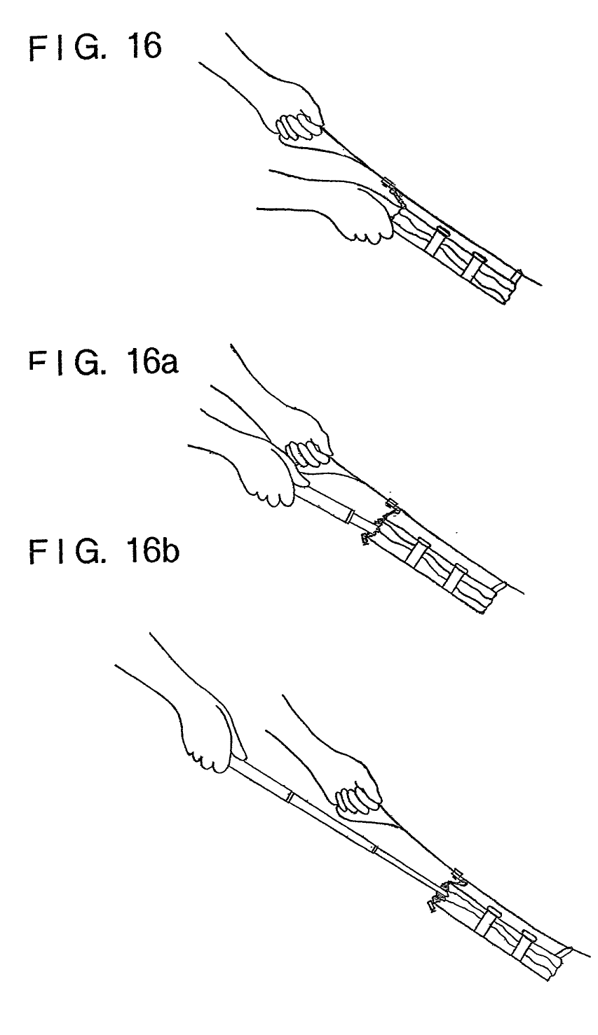

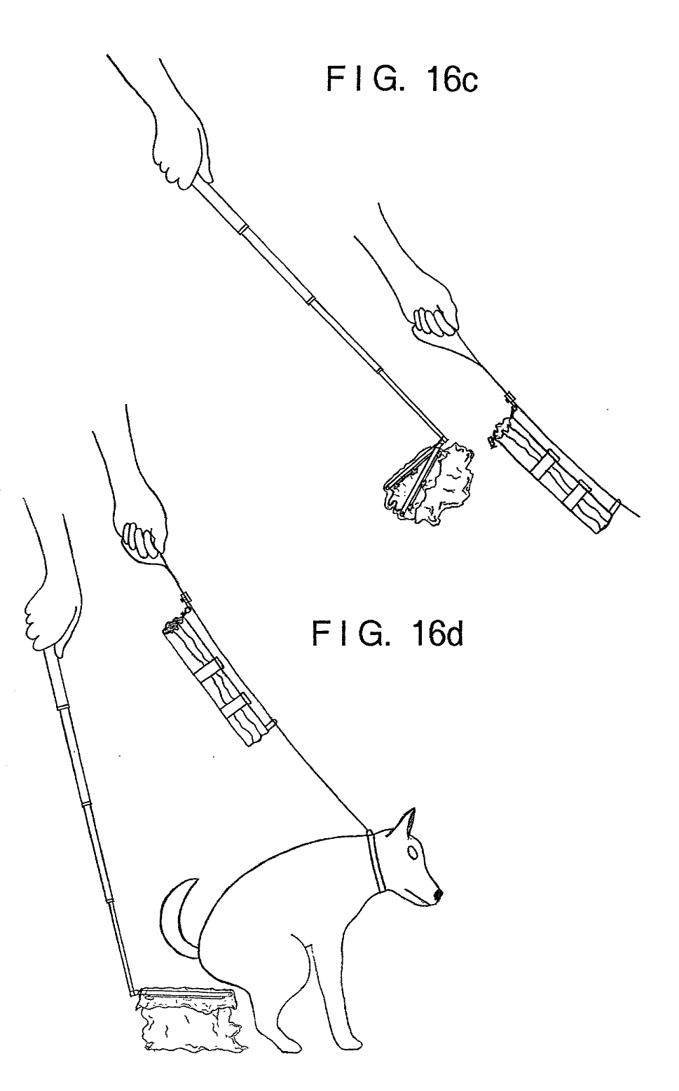

In FIG. 16 the deployment of the present invention can now be understood. Prior to taking the animal for a walk, a bag is inserted onto the pivoting arms in the manner shown in FIG. 8. Then, the arms and body are collapsed together and stored in the case 70. The end may be closed by means of the drawstring to prevent the device from accidentally coming loose. Most preferably it is attached to the lead as described above, but the present invention also comprehends that it could be placed in a pocket, clipped onto the owners belt, or stored in any other convenient hands free location.

In the event the owner notices that the animal is getting ready to defecate, then the owner may deploy the present invention in accordance with FIG. 16, 16a, 16b, 16c and 16d. As shown in FIG. 16, the first step is to grab a free end of the end of the reach extending body 11. In FIG. 16a, the first section of the reach extending body 11 has been retracted from the carrying case 70 of the present invention. It can now be appreciated why the position of being clipped to the leash is preferred, because the case is then accessible, will not move since it is securely clipped and thus facilitates one-handed removal. In FIG. 16b two further sections have been retracted from the carrying case of the present invention leaving the pivoting arms and the bag in the carrying case. In FIG. 16c, the full invention has been retracted from the body and the pivoting arms are being automatically deployed by gravity with the disposable pet excrement-collecting bag being opened. Since the pivot arms are slightly heavy, they will tend to open downwardly as shown. However, the present invention comprehends that the sections of the body are fixed together in a manner to prevent rotation, meaning that by simply turning the top section the pet owner can easily turn over and position the pivot arms as needed, under the animal. In FIG. 16d the unit is fully deployed and in position to capture the pet excrement, and all the while has only required the use of one hand.

When the pet has finished doing its business, the next step is to retract the body and store the bag containing the collected excrement until it is convenient to dispose of the same. To retract the collapsible body 11 the order of the steps is simply reversed as compared to those stated above. First the body is rotated until the pivot arms are hanging down. The weight of the filled excrement-containing bag will tend to rotate pivot arms towards the collapsible body. By simply raising up the free end the body can be collapsed or retracted and as the end is raised the pivot arms rotate to the body closing the open mouth of the bag. In the event the telescoping elements fail to collapse then the end may be pressed against an object to cause it to collapse or if convenient the pet owner may use their other hand on the other end of the body to collapse the body.

Once the body is retracted, the pet owner may, if desired, wind the bag once or twice around the collapsed assembly to further seal the bag against spillage. The whole apparatus may be placed inside the case (with the straps 72 loosened to make room) for subsequent disposal. All of the foregoing steps can be accomplished according to the present invention with one hand, leaving the other hand free to remain on the lead, restraining the pet. Once at a safe or secure location the bag can then be removed from the arms and disposed of in a waste receptacle.

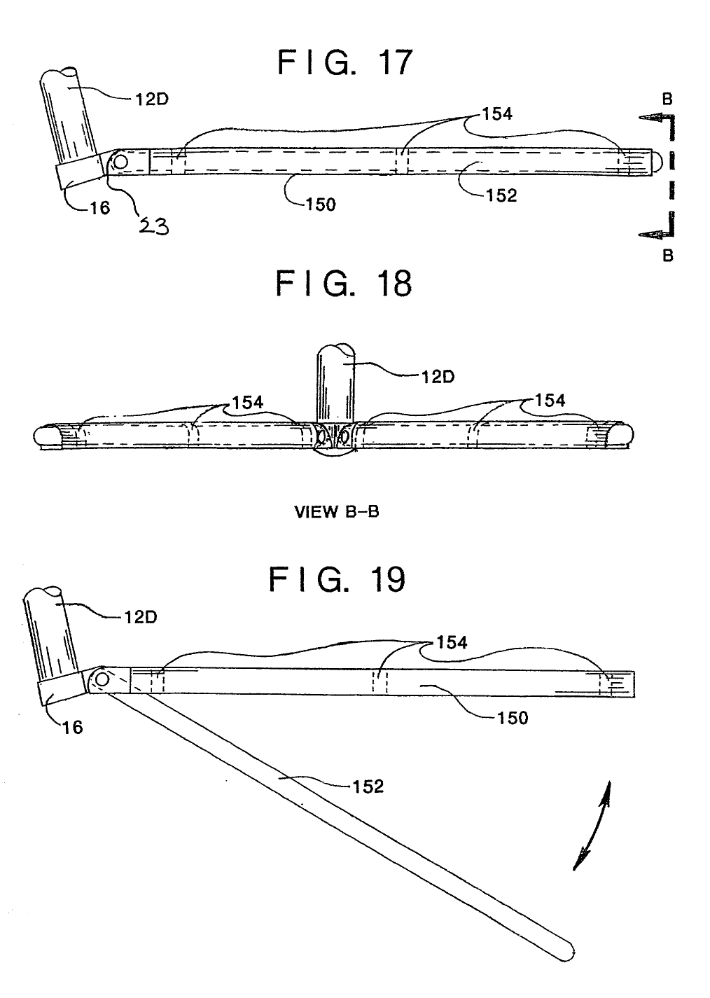

FIGS. 17, 18 and 19 show a further embodiment of the present invention in which a modified bag holding means is shown. In this embodiment the pivoting arm 150 is made generally hollow and frictionally engages a bag-retaining arm 152 therein. The arm 150 as shown includes friction clips 154 to ensure a snug fit with the bag-retaining arm 152. The arm 152 is analogous to arm 20, in that it includes a rotational stop 23 to prevent it from deploying beyond the preferred position. In contrast the bagretaining arm 152 is permitted to pivot further to permit the bag to be tucked under and secured between arms 152 and 154 (see FIG. 19). This form of invention is preferred because it may be equally used with either the inventive bags 140 or with used t-shirt or grocery store bags.

It will be understood by those skilled in the art that while the foregoing description has been made with reference to preferred embodiments of the invention, additional alterations and variations can be made without departing from the broad spirit of the claims which follow. For example, the pivoting arms have been shown having different bag attaching means, which may be suitable for conventional grocery store bags, as well as being suitable for the specifically designed inventive bags of the present invention. Also, while circular shaped body sections are shown other shaped telescoping bodies, such as square or triangular are also comprehended.

I claim:

1. A portable pet excrement collector for use in association with a disposable bag, said collector comprising:
a collapsible reach extending body;
a pair of bag supporting pivoting arms at a distal end of said body;
a rotational stop associated with each of said pivoting arms, and
at least one pivot element pivotally attaching each arm to said body, and said pivot element being sized and shaped to permit said bag supporting pivoting arms to pivot between in a first lower open position in which the pivoting arms extend out from said body and a second raised position in which the pivoting arms are generally parallel to said body and adjacent to one another, said rotational stop supporting said pivot arms in said lowered position, wherein a bag supported on said pivot arms is placed in an open position when said arms are lowered and a closed position when said arms are raised.

2. A portable pet excrement collector for use in association with a disposable bag as claimed in claim 1 wherein said reach extending body is formed from a plurality of telescoping segments.

3. A portable pet excrement collector for use in association with a disposable bag as claimed in claim 2 wherein said pivoting arms have free ends and in said bag open position said bag extends between said free ends to form a generally triangular shaped excrement receiving opening.

4. A portable pet excrement collector for use in association with a disposable bag as claimed in claim 1 wherein said extendable body has a centreline and stop is positioned to place said pivot arms at an angle of between 100° and 125° to said centreline.

5. A portable pet excrement collector for use in association with a disposable bag as claimed in claim 1 wherein said pivot arms form at bag open angel of about 60° to one another.

6. A portable pet excrement collector for use in association with a disposable bag as claimed in claim 1 wherein said reach extending body is formed from a plurality of noncircular telescoping sections.

7. A portable pet excrement collector for use in association with a disposable bag as claimed in claim 6 wherein said reach extending body includes anti-rotational means between adjacent sections to inhibit said sections from rotating relative to one another.

8. A portable pet excrement collector for use in association with a disposable bag as claimed in claim 7 wherein said anti rotational means includes one or more of friction enhanced surfaces, noncircular cross sections, and axially interlocking elements.

9. A portable pet excrement collector for use in association with a disposable bag as claimed in claim 1 wherein said pivot arms further include a means for securing a bag to said arms.

10. A portable pet excrement collector for use in association with a disposable bag as claimed in claim 9 wherein said means for securing a bag to said arms comprises a plurality of cleats and associated elastic retaining elements.

11. A portable pet excrement collector for use in association with a disposable bag as claimed in claim 9 wherein said means for securing a bag to said arms comprises a bag retaining arm pivotally connected to said pivoting arm and being releasably clipped thereto.

12. A portable pet excrement collector for use in association with a disposable bag as claimed in claim 11 wherein said pivoting arm is in the form of a curved hollow section and said bag retaining arm nests inside of said hollow section.

13. A portable pet excrement collector for use in association with a disposable bag as claimed in claim 1 wherein said collector further includes a flexible retaining element extending between the free ends of said pivoting bag supporting arms.

14. A portable pet excrement collector for use in association with a disposable bag as claimed in claim 1 further including a carrying case, said carrying case being sized and shaped to contain said collector when said collector is in a collapsed position.

15. A portable pet excrement collector for use in association with a disposable bag as claimed in claim 1 further including, in combination, a portable excrement scraper.

16. A portable pet excrement collector for use in association with a disposable bag as claimed in claim 14, wherein said carrying case further includes a pocket for a portable excrement scraper.

17. A portable pet excrement collector for use in association with a disposable bag as claimed in claim 14 wherein said carrying case includes an open and a closed end, and said collector may be inserted or withdrawn through said open end.

18. A portable pet excrement collector for use in association with a disposable bag as claimed in claim 17 wherein said carrying case further includes clips to permit said case to be attached to one or more of a leash, a handle or directly to a person.

19. A disposable pet excrement bag for use in association with an excrement collector having two pivoting arms said bag comprising:
a receptacle of flexible plastic material with an opening at a top end thereof;
a first sleeve adjacent to said opening, sized and shaped to fit one of said pivoting arms and including a first sleeve stop; and
a second sleeve adjacent to said opening sized and shaped to fit the other of said pivoting arms and including a second sleeve stop.

20. A disposable pet excrement bag as claimed in claim 19 wherein said first and second sleeves include adjacent sleeve openings.

21. A disposable pet excrement bag as claimed in claim 19 wherein each of said first and second sleeve stops are positioned approximately one third of the way around the open top of said bag.

22. A disposable pet excrement bag as claimed in claim 19 wherein said bag further includes a means for closing the open top of said bag.

23. A disposable pet excrement bag as claimed in claim 22 wherein said means for closing comprises a peel and stick adhesive patch.

24. A disposable pet excrement bag as claimed in claim 22 wherein said means for closing comprises a drawstring closure.
